(19) United States
(12) Patent Application Publication
(10) Pub. No.: US 2022/0033602 A1
(43) Pub. Date: Feb. 3, 2022

(54) WATER-SOLUBLE BARRIER FILM

(71) Applicant: The Procter & Gamble Company, Cincinnati, OH (US)

(72) Inventors: Pier-Lorenzo Caruso, Frankfort am Main (DE); Uwe Bolz, Tutzing (DE); Emily Charlotte Boswell, Cincinnati, OH (US)

(21) Appl. No.: 17/386,584

(22) Filed: Jul. 28, 2021

Related U.S. Application Data
(60) Provisional application No. 63/058,643, filed on Jul. 30, 2020.

(51) Int. Cl. C08J 7/04; C08J 7/056; C08K 3/04; C08K 3/34; C08K 5/00; B05D 7/04; B05D 3/00; B05D 7/00; B05D 7/14; C08K 5/053; C08J 7/06

(52) U.S. Cl. CPC C08J 7/0423; C08J 2371/02; C08K 3/042; C08K 3/346; C08K 5/0016; B05D 7/04; B05D 3/007; B05D 7/5883; B05D 7/14; C08K 5/053; C08J 7/06; C08K 2201/011; B05D 2201/02; B05D 2401/20; C08J 2329/04; C08J 2301/08; C08J 7/056

(57) ABSTRACT

A water-soluble film comprising an integrated water-dispersible barrier against any permeation.

### FIELD OF THE INVENTION

The present invention relates to a water-soluble barrier film, either as standalone film for product applications such as pods, or as component film in laminates for flexible package applications such as sachets, with an integrated water-dispersible barrier against any permeation offering several advantages compared to prior-art water-soluble film executions; and a method for producing water-soluble films with an integrated water-dispersible barrier against any permeation.

### BACKGROUND OF THE INVENTION

Water-soluble films are gaining wider acceptance for use in consumer products, such as liquid detergent pods and automatic dish washer dry powder tablets. To be effective such water-soluble films must maintain properties (strength, permeation barrier) when exposed to chemicals, yet disperse or completely dissolve when immersed in water. The multi-compartment pods introduced by P&G on the market enable the separation of chemistries in top/bottom compartments via a water-soluble film lying flat in the middle of the pod. The water-soluble film must be thick enough to avoid chemicals exchange between the top/bottom compartments, or from exterior contaminants, and must be thin enough to completely dissolve in water during use.

Consumers find that pods may often get sticky over time even when they are not exposed prematurely to water or to a highly humid environment. This is because some of the chemistries held within the pod migrate through the external pod film over time, since today's soluble films are little barrier to the liquid ingredients held within the package. The barrier performance of today's soluble films also causes other issues e.g. migration of chemical species between the separate chambers of a multi-chamber package, making it difficult to separate reactive species even when they are initially separated in different chambers. With time they will diffuse and react together prematurely, before use, limiting the eventual performance of the overall product. Some examples of chemical species present in products that are desirable to limit migration of are: water, perfumes, surfactants, bleaches, hueing dyes, highly migrating Na⁺ cation, Fe²⁺ cation.

A common way of producing water-soluble films is via solution casting. An example of commercially available water-soluble film is M8630 from MonoSol LLC in Gary, Ind., USA. Other example of commercially available water-soluble film is traded as Solublon® from Aicello.

Using this current technology, it is only possible to produce a water-soluble film as one layer or monolayer. For those applications where barrier functionality is desirable, the prior art opted for either applying the barrier materials on top of the already formed water-soluble film or dispersing the barrier materials within the components of the water-soluble film. An example of barrier materials dispersed within the components of the water-soluble film is given in the patent application WO2007/027224. If the barrier material is applied on top of the already formed water-soluble film, the seal ability of the water-soluble film on the coated surface is affected, or the barrier performance is negligible. If the barrier material is dispersed within the components of the water-soluble film, the solubility of the water-soluble film is affected, or the barrier performance is negligible. In both cases the barrier performance must be balanced together with other important film properties, thus lowering the barrier performance.

Water-soluble films are also produced via melt extrusion. This process is capable to produce water-soluble multilayer films, provided that the rheological properties and interfacial energies among the different layers do not substantially differ. For those applications where barrier functionality is desirable, the prior art dispersed the barrier materials within the components of the middle layer of the water-soluble film. Also, in this case, water solubility and barrier performance must be balanced together, thus lowering the barrier performance.

As such, there remains an unmet need for water-soluble films and packages made therefrom, such as sachets and pouches, which have improved barrier when exposed to vapour, and yet dissolve or disperse to sufficiently small sized particles sufficiently fast when immersed or exposed to water, such as rinse water or wash water. Sufficiently small and fast depends on the particular product application. For a Single Unit Dose article (SUD), the time required will be less than the wash cycle of the washing machine. For a package for a shower body or hair wash product, the time is less than the average shower time, and for a package that might end up being littered the time is less than a day. Dispersion should be to the extent that the material is compatible with the drainage systems without compromising the product performance. It is therefore an aspect of the present invention to provide a water-soluble film having improved barrier against diffusion of undesired chemicals (even water vapour) prior to being thoroughly immersed in water, yet can subsequently substantially dissolve or disperse when immersed in water, such as rinse water or wash water.

### SUMMARY OF THE INVENTION

A water-soluble film with an integrated water-dispersible barrier is provided that comprises a first water-soluble polymeric layer having a plane; a second water-soluble polymeric layer having a plane; a water-dispersible barrier layer disposed between the first and second water-soluble polymeric layers.

Method of making a water-soluble film is provided that comprises applying a first aqueous solution of a water-soluble polymeric composition onto the surface of a removeable flat carrier, such as PET films or steel belts; removing the water from the first aqueous solution of a water-soluble polymeric composition to obtain a first water-soluble polymeric layer; applying an aqueous dispersion of hydrophilic nanoplatelets onto the surface of the first water-soluble polymeric layer; removing the water from the aqueous dispersion of hydrophilic nanoplatelets to obtain a water-dispersible barrier layer; applying a second aqueous solution of a water-soluble polymeric composition onto the surface of the water-dispersible barrier layer; removing the water from the second aqueous solution of a water-soluble polymeric composition to obtain a second water-soluble polymeric layer; removing the flat carrier from the resulting water-soluble barrier film.

### BRIEF DESCRIPTION OF THE DRAWINGS

FIG. 1 shows a cross-section of a water-soluble polymeric layer.

FIG. 2 shows a cross-section of a water-dispersible nanoplatelets layer coated onto a water-soluble polymeric layer.

FIG. 3 shows a cross-section of a water-soluble film with an integrated water-dispersible barrier.

FIG. 4 shows a cross-sectional image obtained via scanning electron microscopy of a water-soluble film with an integrated water-dispersible barrier.

FIG. 5 shows a schematic representation of a method of making a water-soluble film with an integrated water-dispersible barrier.

FIG. 6 shows a schematic representation of an application of a water-soluble film with an integrated water-dispersible barrier.

### DETAILED DESCRIPTION OF THE INVENTION

The invention describes a water-soluble film with an integrated water-dispersible barrier against water vapour permeation offering several advantages compared to prior art water-soluble films; and a method for making water-soluble films with an integrated water-dispersible barrier layer.

As used herein, the term “water vapour transmission rate” or “WVTR” refers to the rate at which water vapour is transmitted through a film, when measured according to the Water Vapour Transmission Test Method set forth in the Test Methods section.

As used herein, the term “dissolution time” refers to the time required for a water-soluble film (such as a film made of a polyvinyl alcohol) to be dissolved, when measured according to the Dissolution Test Method set forth in the Test Methods section.

As used herein, the term “water-dispersible” means breaking apart in water in small fragments smaller than a millimeter. These fragments can, but do not need to be stably suspended in water.

As used herein, the term “copolymer” means a polymer formed from two, or more, types of monomeric repeating units. The term “copolymer” as used herein further encompasses terpolymers, such as terpolymers having a distribution of vinyl alcohol monomer units, vinyl acetate monomer units, and possibly butene diol monomer units; however, if the copolymer is substantially fully hydrolyzed, substantially no vinyl acetate monomeric units may be present.

As used herein, the term “degree of hydrolysis” refers to the mole percentage of vinyl acetate units that are converted to vinyl alcohol units when a polymeric vinyl alcohol is hydrolyzed.

As used herein, when the term “about” modifies a particular value, the term refers to a range equal to the particular value, plus or minus twenty percent (±20%). For any of the embodiments disclosed herein, any disclosure of a particular value, can, in various alternate embodiments, also be understood as a disclosure of a range equal to about that particular value (i.e. ±20%).

As used herein, when the term “approximately” modifies a particular value, the term refers to a range equal to the particular value, plus or minus fifteen percent (±15%). For any of the embodiments disclosed herein, any disclosure of a particular value, can, in various alternate embodiments, also be understood as a disclosure of a range equal to approximately that particular value (i.e. ±15%).

As used herein, when the term “substantially” modifies a particular value, the term refers to a range equal to the particular value, plus or minus ten percent (±10%). For any of the embodiments disclosed herein, any disclosure of a particular value, can, in various alternate embodiments, also be understood as a disclosure of a range equal to approximately that particular value (i.e. ±10%).

As used herein, when the term “nearly” modifies a particular value, the term refers to a range equal to the particular value, plus or minus five percent (±5%). For any of the embodiments disclosed herein, any disclosure of a particular value, can, in various alternate embodiments, also be understood as a disclosure of a range equal to approximately that particular value (i.e. ±5%).

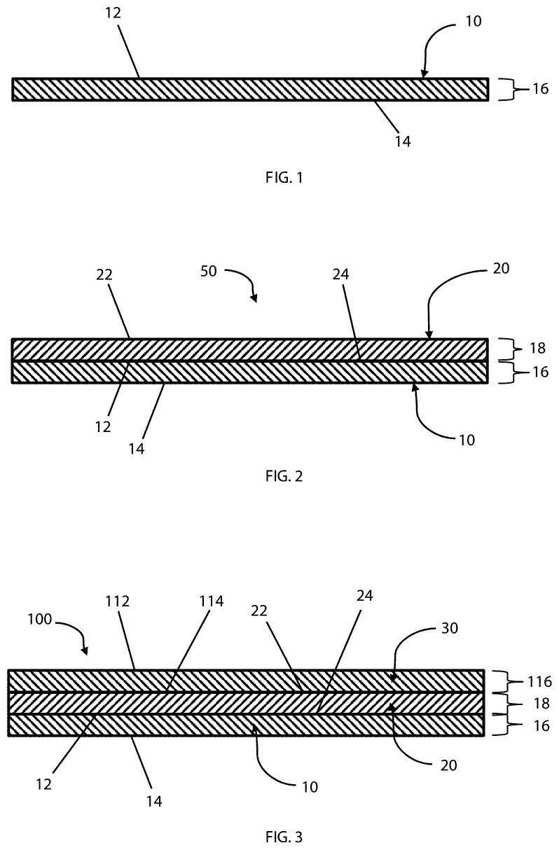

FIG. 1 shows a cross-section of a water-soluble polymeric layer 10. The water-soluble polymeric layer 10 has a first surface 12 and a second surface 14 opposite to the first surface 12, and a thickness 16 between the first surface 12 and the second surface 14.

The thickness of the water-soluble polymeric layer 10 between the first surface 12 and the second surface 14 can range from about 1 μm to about 1000 μm, preferably from about 10 μm to about 250 μm, more preferably from about 25 μm to about 125 μm.

The water-soluble polymeric layer 10 comprises at least one water-soluble polymer. Depending on the application, the water-soluble polymer(s) can be selected among available options to dissolve in water at 23° C. temperature within seconds, or minutes, or hours. A polymer requiring more than 24 hours to dissolve in water at 23° C. temperature will not be considered as water-soluble.

FIG. 2 shows a cross-section of a water-dispersible barrier layer 20 having a first surface 22 and a second surface 24 opposite the first surface 22, and a thickness 18 between the first surface 22 and the second surface 24, applied to substantially cover at least one of the first surface 12 or the second surface 14 of the water-soluble polymeric layer 10.

The thickness of the water-dispersible barrier layer 20 ranges from about 0.1 μm to about 20 μm, preferably from about 0.1 μm to about 10 μm, more preferably from about 0.1 μm to about 5 μm.

The water-dispersible barrier layer 20 contains 90-100% nanoplatelets, more preferably 96% to 100% nanoplatelets, even more preferably 99-100% nanoplatelets, such as sodium cloisite or sodium hectorite, and is substantially free from other materials in the interstices between the assembled nanoplatelets, such as binders, dispersants, surfactants, or water-soluble polymers. This means that the cohesion of the nanoplatelets layer is solely provided by the interactions between the nanoplatelets and the adhesion to the water-soluble polymeric layers is solely provided by the interactions between the nanoplatelets and the water-soluble polymers. The absence of binders (interstitial materials) in the nanoplatelets layer maximizes the barrier performance of the nanoplatelets layer against water permeation whilst maintaining the dispersibility of the hydrophilic nanoplatelets in water once the top/bottom water-soluble polymeric layers are removed via dissolution in water during use. A nanoplatelet requiring more than 24 hours to disperse in water at 23° C. temperature will not be considered as dispersible in water.

Nanoplatelets are plate-like nanoparticles characterized by high aspect ratio between the diameter and the orthogonal height. The high aspect ratio enables a “brick wall’ to be formed where nanoplatelets lay down parallel to the surface of the underlying water-soluble polymeric layer, overlapping each other and laying on top of each other, thus lowering drastically the migration of molecules, whether gaseous or liquid, through the nanoplatelets layer. The higher the aspect ratio, the higher the barrier performance that can be obtained. Typical aspect ratio for montmorillonite exfoliated nanoplatelets is about 100 or more (Cadene et all, JCIS 285(2):719-30. June 2005).

The water-dispersible barrier layer 20 according to the present invention may be optically opaque, preferably translucent, even more preferably transparent, depending on the nanoplatelets material (exfoliation level, impurities level) and the nanoplatelets application process.

Preferably, the water-dispersible barrier layer 20 is flexible and stretchable. When converting the water-soluble film according to the invention through a line for printing, sheeting, slitting, rewinding and other typical converting operations to make articles such as pouches, the water-soluble film according to the invention may be elongated up to 200%. This can cause the water-dispersible barrier layer 20 to break. It is thus preferred that the water-dispersible barrier layer 20 is flexible and stretchable without breaking. Preferably, the water-dispersible barrier layer 20 can be elongated at least 20%, more preferably at least 30%, even more preferably at least 50%, most preferably at least 100% and up to 200% without breaking.

FIG. 3 shows a cross-section of a water-soluble film with an integrated water-dispersible barrier 100 comprising a first water-soluble polymeric layer 10. The water-soluble polymeric layer 10 has a first surface 12 and a second surface 14 opposite to the first surface 12, and a thickness 16 between the first surface 12 and the second surface 14. The water-soluble polymeric layer 10 can be in the form of a film or a sheet. A barrier layer 20, having a first surface 22 and a second surface 24 opposite the first surface 22, and a thickness 18 between the first surface 22 and the second surface 24, is applied to and substantially covers at least one of the first surface 12 or second surface 14 of the water-soluble polymeric layer 10. A second water-soluble polymeric layer 30 is applied, having a first surface 112 and a second surface 114 opposite to the first surface 112, and a thickness 116 between the first surface 112 and the second surface 114, such that the second surface of the water-soluble polymeric layer substantially covers at least one of the first surface 22 or second surface 24 of the water-dispersible barrier layer 20. The water-soluble polymeric layer 30 can be in the form of a film or a sheet. The adhesion between the layers is provided by the interactions between the water-soluble polymers and the hydrophilic nanoplatelets.

The thickness of the water-soluble polymeric layer 30 between the first surface 112 and the second surface 114 can range from about 1 μm to about 1000 μm, preferably from about 10 μm to about 250 μm, more preferably from about 25 μm to about 125 μm.

The water-soluble polymeric layer 30 comprises at least one water-soluble polymer. Depending on the application, the water-soluble polymer(s) can be selected among available options to dissolve in water at 23° C. temperature within seconds, or minutes, or hours. A polymer requiring more than 24 hours to dissolve in water at 23° C. temperature will not be considered as water-soluble.

Each layer according to the present invention is distinct and separated from the others. By distinct layer, it is meant that the barrier layer 20 within the water-soluble film 100 comprises substantially nanoplatelets only, and that the boundaries between the barrier layer 20 and the surrounding water-soluble polymeric layers 10 and 30 are distinguished by a large composition change over a small distance, creating a sharp boundary that is readily seen by microscopy techniques known in the art.

The boundary layer, i.e. the intermediate layer of intermediate composition between the water-dispersible nanoplatelets layer and the adjacent water-soluble polymeric layer, is no more than 2 μm thick, seen by microscopy techniques known in the art.

When the water-soluble film according to the invention is immersed in water (i.e. in applications where the water-soluble film is required to disappear in water), the water-soluble polymeric layers surrounding and supporting the nanoplatelets barrier layer dissolve in water, the barrier layer breaks up, the nanoplatelets disperse in water, thus enabling the entire film to disappear in water.

The water-soluble film comprising a water-dispersible barrier layer according to the invention may be opaque, preferably translucent, even more preferably transparent, depending on the materials.

The water-soluble film according to the invention may comprise a printed area. Printing may be achieved using standard printing techniques, such as flexographic, gravure, or inkjet printing.

### Water-Soluble Polymers

Preferred polymers, copolymers or derivatives thereof suitable for use as water-soluble polymeric layer are selected from polyvinyl alcohol (PVOH), polyvinyl alcohol copolymers such as butenediol-vinyl alcohol copolymers (BVOH), which are produced by copolymerization of butenediol with vinyl acetate followed by the hydrolysis of vinyl acetate, suitable butenediol monomers being selected from 3,4-diol-1-butene, 3,4-diacyloxy-1-butenes, 3-acyloxy-4-ol-1-butenes, 4-acyloxy-3-ol-1-butenes and the like; polyvinyl pyrrolidone; polyalkylene oxides, such as polyethylene oxides or polyethylene glycols (PEG); poly(methacrylic acid), polyacrylic acids, polyacrylates, acrylate copolymers, maleic/acrylic acids copolymers; polyacrylamide; poly(2-acrylamido-2-methyl-1-propanesulfonic acid (polyAMPS); polyamides, poly-N-vinyl acetamide (PNVA); polycarboxylic acids and salts; cellulose derivatives such as cellulose ethers, methylcellulose, hydroxyethyl cellulose, carboxymethylcellulose; hydroxypropyl methylcellulose; natural gums such as xanthan and carrageenan gum; sodium alginates; maltodextrin, low molecular weight dextrin; polyamino acids or peptides; proteins such as casein and/or caseinate (e.g. such as those commercialized by Lactips).

The most preferred polymer is polyvinyl alcohol, polyethylene oxide, methylcellulose and sodium alginate. For applications where a “plastic free” product is desired, the majority component of the water-soluble polymer layer may be a naturally derived polymer, such as sodium alginate. Preferably, the level of polymer in the water-soluble polymeric layer is at least 60%.

The water-soluble polymer has an average molecular weight (measured by gel permeation chromatography) of about 1,000 Da to about 1,000,000 Da, or any integer value from about 1,000 Da to about 1,000,000 Da, or any range formed by any of the preceding values such as about 10,000 Da to about 300,000 Da, about 20,000 Da to about 150,000 Da, etc. More specifically polyvinyl alcohol would have a molecular weight in the range of 20,000-150,000 Da. Polyethylene oxide would have a molecular weight in the range of 50,000 Da to 400,000 Da. Methylcelluloses would have a molecular weight in the range 10,000 Da to 100,000 Da. Methylcellulose may be methoxyl substituted, for example from about 18% to about 32% and may be hydroxy-propoxyl substituted, for example from about 4% to about 12%. Sodium alginate would have a molecular weight in the range 10,000 to 240,000 Da.

If homopolymer polyvinyl alcohol is used, the degree of hydrolysis could be 70-100%, or any integer value for percentage between 70% and 100%, or any range formed by any of these values, such as 80-100%, 85-100%, 90-100%, 95-100%, 98-100%, 99-100%, 85-99%, 90-99%, 95-99%, 98-99%, 80-98%, 85-98%, 90-98%, 95-98%, 80-95%, 85-95%, 90-95%, etc.

### Optional Ingredients

The water-soluble polymeric layers of the water-soluble film with an integrated water-dispersible barrier may contain disintegrants, plasticizers, surfactants, lubricants/release agents, fillers, extenders, antiblocking agents, detackifying agents, antifoams, or other functional ingredients. In the case of articles containing compositions for washing, the water-soluble polymeric layers may include functional detergent additives to be delivered to the wash water, for example organic polymeric dispersants, or other detergent additives.

It may be required for certain applications that the water-soluble polymeric layers contain disintegrants to increase the dissolution rate in water of the water-soluble film with an integrated water-dispersible barrier. Suitable disintegrants are, but are not limited to, corn/potato starch, methyl celluloses, mineral clay powders, croscarmellose (cross-linked cellulose), crospovidone (cross-linked polyvinyl N-pyrrolidone, or PVP), sodium starch glycolate (cross-linked starch). Preferably, the water-soluble polymeric layers comprise between 0.1% and 15%, more preferably from about 1% to about 15% by weight of disintegrants.

Preferably, the water-soluble polymeric layers may contain water-soluble plasticizers. Preferably, the water-soluble plasticizer is selected from water, polyols, sugar alcohols, and mixtures thereof. Suitable polyols include polyols selected from the group consisting of glycerol, diglycerol, ethylene glycol, diethylene glycol, triethylene glycol, tetraethylene glycol, polyethylene glycols up to 400 Da molecular weight, neopentyl glycol, 1,2-propylene glycol, 1,3-propanediol, dipropylene glycol, polypropylene glycol, 2-methyl-1,3-propanediol, methylene glycol, trimethylolpropane, hexylene glycol, neopentyl glycol, and polyether polyols, or a mixture thereof. Suitable sugar alcohols include sugar alcohols selected from the group consisting of isomalt, maltitol, sorbitol, xylitol, erythritol, adonitol, dulcitol, pentaerythritol and mannitol, or a mixture thereof. In some cases, the plasticizer could be selected from the following list: ethanolamine, alkyl citrate, isosorbide, pentaerythritol, glucosamine, N-methylglucamine or sodium cumene sulfonate. Less mobile plasticizers such as sorbitol or polyethylene oxide can facilitate the formation of water-soluble polymeric layers with greater barrier properties than water-soluble polymeric layers including a more mobile plasticizer such as glycerol. In some circumstances when there is a desire to use as many naturally derived materials as possible, the following plasticizers could also be used: vegetable oil, polysorbitol, dimethicone, mineral oil, paraffin, C₁-C₃ alcohols, dimethyl sulfoxide, N, N-dimethylacetamide, sucrose, corn syrup, fructose, dioctyl sodium-sulfosuccinate, triethyl citrate, tributyl citrate, 1,2-propylene glycol, mono, di- or triacetates of glycerin, natural gums, citrates, and mixtures thereof. More preferably, water-soluble plasticizers are selected from glycerol, 1,2-propanediol, 20 dipropylene glycol, 2-methyl-1,3-propanediol, trimethylolpropane, triethylene glycol, polyethylene glycol, sorbitol, or a mixture thereof, most preferably selected from glycerol, sorbitol, trimethylolpropane, dipropylene glycol, and mixtures thereof. Preferably, the water-soluble polymeric layers comprise between 5% and 50%, more preferably between 10% and 40%, even more preferably from about 12% to about 30% by weight of plasticizers.

Preferably, the water-soluble polymeric layers according to the invention comprises a surfactant. Suitable surfactants may belong to the non-ionic, cationic, anionic or zwitterionic classes. Suitable surfactants are, but are not limited to, poloxamers (polyoxyethylene polyoxypropylene glycols), alcohol ethoxylates, alkylphenol ethoxylates, tertiary acetylenic glycols and alkanolamides (nonionic), polyoxyethylene amines, quaternary ammonium salts and quaternized polyoxyethylene amines (cationic), and amine oxides, N-alkylbetaines and sulfobetaines (zwitterionic). Other suitable surfactants are dioctyl sodium sulfosuccinate, lactylated fatty acid esters of glycerol and propylene glycol, lactylic esters of fatty acids, sodium alkyl sulfates, polysorbate 20, polysorbate 60, polysorbate 65, polysorbate 80, lecithin, acetylated fatty acid esters of glycerol and propylene glycol, and acetylated esters of 5 fatty acids, and combinations thereof. Preferably, the water-soluble polymeric layers comprise between 0.1% and 2.5%, more preferably from about 1% to about 2% by weight of surfactants.

Preferably the water-soluble polymeric layers according to the invention comprises lubricants/release agents. Suitable lubricants/release agents are, but are not limited to, fatty acids and their salts, fatty alcohols, fatty esters, fatty amines, fatty amine acetates and fatty amides. Preferred lubricants/release agents are fatty acids, fatty acid salts, fatty amine acetates, and mixtures thereof. Preferably, the water-soluble polymeric layers comprise between 0.02% to 1.5%, more preferably from about 0.1% to about 1% by weight of lubricants/release agents.

Preferably the water-soluble polymeric layers according to the invention comprises fillers, extenders, antiblocking agents, detackifying agents. Suitable fillers, extenders, antiblocking agents, detackifying agents are, but are not limited to, starches, modified starches, crosslinked polyvinylpyrrolidone, crosslinked cellulose, microcrystalline cellulose, silica, metallic oxides, calcium carbonate, talc, and mica. Preferably, the water-soluble polymeric layers comprise between 0.1% to 25%, more preferably from about 1% to about 15% by weight of fillers, extenders, antiblocking agents, detackifying agents. In absence of starch, the water-soluble polymeric layers comprise preferably between 1% to 5% by weight of fillers, extenders, antiblocking agents.

Preferably the water-soluble polymeric layers according to the invention comprises antifoams. Suitable antifoams are, but are not limited to, polydimethylsiloxanes and hydrocarbon blends. Preferably, the water-soluble polymeric layers comprise between 0.001% and 0.5%, more preferably from about 0.01% to about 0.1% by weight of antifoams.

Benefit agents may also be incorporated in the water-soluble polymeric layers. As such, it is possible to deliver benefit agents via articles such as pouches, which are not compatible with the product or composition inside the article. Examples of benefit agents are, but are not limited to, cleaning agents, soil suspending agents, anti-redeposition agents, optical brighteners, bleaches, enzymes, perfume compositions, bleach activators and precursors, shining agents, suds suppressor agents, fabric caring compositions, surface nurturing compositions.

Bittering agents may also be incorporated in the outer water-soluble polymeric layer, which is legally required in some regions for certain applications such as pods. Suitable bittering agents are, but are not limited to, naringin, sucrose octa-acetate, quinine hydrochloride, denatonium benzoate, or mixtures thereof. Preferably, the water-soluble polymeric layers comprise between 1 ppm and 5000 ppm, more preferably from about 100 ppm to about 2500 ppm, even more preferably from about 250 ppm to about 2000 ppm by weight of bittering agents.

The water-soluble film or water-soluble article according to the invention may be coated with antiblocking/detackifying agents. Suitable antiblocking/detackifying agents are, but are not limited to, talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

The water-soluble film according to the invention may contain residual moisture depending on the hygroscopy of the water-soluble film components and the isotherm of the water-soluble film at given temperature and humidity conditions measured by Karl Fischer titration. For instance, water-soluble polyvinyl-alcohol films may contain about 4-8% residual moisture at 23° C. and 50% r.H.

### Water-Dispersible Nanoplatelets

Nanoplatelets are solid plate-like nanoparticles characterized by high aspect ratio between the diameter and the orthogonal height. High aspect ratio delivers a parallel arrangement of the nanoplatelets, and a longer diffusion path length for chemicals through the nanoplatelets, thus delivering barrier functionality. It is desirable that nanoplatelets are free from defects such as cracks and holes lowering the barrier performance. It is also desirable that nanoplatelets are easily exfoliated in water, both for application purpose (e.g. wet coating) and end-of-life scenarios (e.g. wastewater treatment plants), but highly cohesive when dried. Nanoplatelets are currently used in the industry as rheological modifier, flame retardant, anticorrosion coating and/or chemical barrier. Nanoplatelets can be obtained from natural sources and used as such, or can purified and modified from natural sources, or can be synthetised in furnaces for purity and performance reasons.

Natural phyllosilicates, such as serpentine, clay, chlorite and mica, consist of nanoplatelets stacked together. Natural clays, such as kaolinite, pyrophyllite, vermiculite and smectite, consist of nanoplatelets stacked together, swelling in presence of water. Smectites, such as montmorillonite and hectorite, consist of nanoplatelets stacked together, swelling the most in presence of water. Natural smectites can be purified and modified, such as sodium cloisite from BYK, obtained from bentonite, a natural mineral containing 60-80% montmorillonite, and cationic exchanged with monovalent sodium for exfoliation purposes. Smectites can be also synthetised, such as laponite from BYK, and sodium hectorite from the University of Bayreuth. Other nanoplatelets are graphene and graphene oxides, such as those supplied by Applied Graphene Materials, and are also characterized by high aspect ratio between the diameter and its orthogonal height.

### Methods of Making a Water-Soluble Barrier Film

There are numerous non-limiting embodiments for making water-soluble films with an integrated water-dispersible barrier described herein. As shown in FIG. 5, a water-soluble film with an integrated water-dispersible barrier may be produced in multiple steps of coating and drying of aqueous polymeric solution or aqueous nanoplatelets dispersion under specific conditions.

In one non-limiting embodiment of the method, a water-soluble polymeric layer 10 is formed onto the surface of a flat carrier (e.g. untreated PET film, stainless steel belt, fluorinated polymeric belt or any other suitable carrier materials); a water-dispersible nanoplatelets layer 20 is formed onto at least one of the surfaces 12, 14 of the previously formed water-soluble polymeric layer 10; a second water-soluble polymeric layer 30 is then formed onto at least one of the surfaces 112, 114 of the previously formed water-dispersible nanoplatelets layer; the flat carrier is finally removed from the resulting water-soluble barrier film.

To make water-soluble polymeric layer 10 or 30, an aqueous polymeric solution is typically formed by taking the water-soluble polymer as solid form and first dissolving it into water using moderate stirring, typically 20% water-soluble polymers for 80% water by weight. The aqueous polymeric solution is then further combined with other additives such as plasticizers under moderate stirring at high temperature. The aqueous polymeric solution is then coated onto a flat surface carrier (e.g. untreated PET film, stainless steel belt, fluorinated polymeric belt or any other suitable materials) and the water removed via convective or diffusive drying process.

Without being limited to theory, it is believed that the most important material properties of the aqueous polymeric solution are: a) the solubility in water of the polymer(s) at given temperature between 20-95° C.; b) the resulting viscosity of the aqueous polymeric solution at that temperature, higher viscosity being better for maximum distinction/separation between the layers; c) the wetting of the aqueous polymeric solution either onto a flat carrier, or onto a water-dispersible nanoplatelets layer, or onto another water-soluble polymeric layer, higher wetting being better.

The drying step is typically performed by conveyor dryers, such as those commercialized by Krönert under the brand name Drytec, by Coatema under the brand name ModulDry and/or by FMP Technologies GmbH (Erlangen, Germany) under the brand name SenDry or PureDry. In some embodiments, the drying substrate is guided through the hot air tunnel by a running belt (belt dryers), by multiple idlers (rolling dryers) or by multiple hot air nozzles (floatation dryers). Without being limited to theory, it is believed that the most important parameters of the drying process are: The residence time of the drying substrate into the hot air tunnel, typically about 50 s for 60μ thick aqueous polymeric solution containing 25% solids; the temperature of the hot air, typically about 95° C.; the velocity of the hot air flowing above the substrate, typically about 25 m/s. The heating system can be electrical, thermal oil, steam or gas-fire based.

To make water-dispersible nanoplatelets layer 20, an aqueous nanoplatelets dispersion is typically formed by taking the water-dispersible nanoplatelets as solid form and first exfoliating them under high shear (e.g. high energy ball milling) with some water, typically 80% water-dispersible nanoplatelets for 20% water by weight. The aqueous nanoplatelets dispersion is then further diluted in water under vigorous stirring at moderate temperature. The aqueous nanoplatelets dispersion is then coated onto the first water-soluble polymeric layer and the water is then removed via drying.

Without being limited to theory, it is believed that the most important material property of the nanoplatelets are: a) the aspect ratio of the nanoplatelets (the higher aspect ratio being the better for barrier performance); b) the total exfoliation and dispersion of the nanoplatelets in water under intense shear mixing, without nanoplatelets re-agglomeration, allowing a substantially homogeneous coating of evenly distributed nanoplatelets, such that the homogeneous coating is without defects, such as pinholes or cracks. Without being limited to theory, it is also believed that the most important processability properties of aqueous nanoplatelets dispersions are: the viscosity of the aqueous nanoplatelets dispersion, higher viscosities being better for maximum distinction/separation between the layers and therefore maximum barrier performance; the wetting of the aqueous nanoplatelets dispersion either onto a water-soluble polymeric layer or onto another water-dispersible nanoplatelets layer; the shear applied on the aqueous nanoplatelets dispersion, the higher being the better for parallel nanoplatelets orientation to the barrier plane; the water removal from the dispersion via diffusive drying without generating defects in the nanoplatelets layer.

Many processes were tested for coating aqueous nanoplatelets dispersions: wire rod coating, anilox roll coating, reverse roll coating, slot die extrusion coating, roll-to-roll coating, and spray coating. Aqueous extrusion coating via tailored slot die (e.g. FMP Technology, Coatema) proved the most reliable processes provided proper infeed of the aqueous nanoplatelets dispersion, whereas roll-to-roll process delivered the best barrier performance via superior shearing of the aqueous nanoplatelets dispersion, hence superior parallel orientation of the nanoplatelets. That barrier performance is nonetheless also dependent to the overall thickness of the water-dispersible nanoplatelets layer. Typically, the thickness of the water-dispersible nanoplatelets layer is in the range 1-10 μm to provide an adequate barrier performance whilst maintaining sufficient mechanical flexibility and mechanical resistance.

In another non-limiting embodiment, the water-dispersible nanoplatelets barrier layer 20 is obtained in multiple application steps of coating and drying the aqueous nanoplatelets dispersion, each nanoplatelets sublayer masking hypothetical defects in the underlaying nanoplatelets sublayer, thus delivering maximum barrier performance. To do so, a first water-dispersible nanoplatelet barrier sublayer is formed onto the water-soluble polymeric layer 10 according to any of the above-mentioned methods; Subsequently, one or more additional water-dispersible nanoplatelets barrier sublayers may be added until the desired water-dispersible nanoplatelets layer thickness is obtained. Following this method, relatively thick water-dispersible nanoplatelets layers can be formed. Where increased optical transparency and mechanical flexibility is desired, the additional water-dispersible nanoplatelets barrier sublayers can be separated by additional thin water-soluble polymeric sublayers. The various polymeric or barrier sublayers may have substantially the same chemical composition or a different one, to deliver different properties to the overall structure. The adhesion between the sublayers is solely provided by the molecular interactions between the water-soluble polymers and the hydrophilic nanoplatelets. Similarly, the cohesion among the water-dispersible nanoplatelets barrier sublayers is solely provided by the molecular interactions among the water-dispersible nanoplatelets, without using binders. The absence of binders maximizes the barrier performance against water permeation and maintains the dispersibility of the nanoplatelets in water once the top/bottom polymeric layers are dissolved.

### Methods of Making Water-Soluble Articles

The water-soluble film with an integrated water-dispersible barrier described herein can be formed into articles, including but not limited to those in which water-soluble film with an integrated water-dispersible barrier is used as a packaging material. Such articles include, but are not limited to water-soluble pouches, sachets, and other containers. Water-soluble pouches and other such containers that incorporate the water-soluble film with an integrated water-dispersible barrier described herein can be made in any suitable manner known in the art. The water-soluble film with an integrated water-dispersible barrier can be provided either before or after forming the same into the final article. In either case, in certain embodiments it is desirable when making such articles, that the surface of a water-soluble polymeric layer onto which the barrier layer is applied, forms an outer surface of the article.

There are number of processes for making water-soluble articles. These include but are not limited to processes known in the art such as: vertical form fill sealing processes, horizontal form fill sealing processes, and formation of the pouches in molds on the surface of a circular drum. In vertical form fill sealing processes, a vertical tube is formed by folding a substrate. The bottom end of the tube is sealed to form an open pouch. This pouch is partially filled allowing a head space. The top part of the open pouch is then subsequently sealed together to close the pouch, and to form the next open pouch. The first pouch is subsequently cut, and the process is repeated. The pouches formed in such a way usually have pillow shape. Horizontal form fill sealing processes use a die having a series of molds therein. In horizontal form fill sealing processes, a substrate is placed in the die and open pouches are formed in these molds, which can then be filled, covered with another layer of substrate, and sealed. In the third process (formation of pouches in molds on the surface of a circular drum), a substrate is circulated over the drum and pockets are formed, which pass under a filling machine to fill the open pockets. The filling and sealing take place at the highest point (top) of the circle described by the drum, e.g. typically, filling is done just before the rotating drum starts the downwards circular motion and sealing just after the drum starts its downwards motion. In any of the processes that involve a step of forming of open pouches, the substrate can initially be molded or formed into the shape of an open pouch using thermoforming, vacuum forming, or both. Thermoforming involves heating the molds and/or the substrate by applying heat in any known way such as contacting the molds with a heating element, or by blowing hot air or using heating lamps to heat the molds and/or the substrate. In the case of vacuum forming, vacuum assistance is employed to help drive the substrate into the mold. In other embodiments, the two techniques can be combined to form pouches, for example, the substrate can be formed into open pouches by vacuum forming, and heat can be provided to facilitate the process. The open pouches are then filled with the composition to be contained therein. The filled, open pouches are then closed, which can be done by any method. In some cases, such as in horizontal pouch forming processes, the closing is done by continuously feeding a second material or substrate, such as a water-soluble substrate, over and onto the web of open pouches and then sealing the first substrate and second substrate together. The second material or substrate can comprise the water-soluble polymeric layer 10 described herein. It may be desirable for the surface of the second substrate onto which the barrier layer is applied, to be oriented so that it forms an outer surface of the pouch.

In such a process, the first and second substrates are typically sealed in the area between the molds, and, thus, between the pouches that are being formed in adjacent molds. The sealing can be done by any method. Methods of sealing include heat sealing, solvent welding, and solvent or wet sealing. The sealed webs of pouches can then be cut by a cutting device, which cuts the pouches in the web from one another, into separate pouches. Processes of forming water-soluble pouches are further described in U.S. patent application Ser. No. 09/994,533, Publication No. US 2002/0169092 A1, published in the name of Catlin, et al.

The sealing mechanism can be thermal heat sealing, water sealing, moisture sealing, ultrasonic sealing, infrared sealing, or any other type of sealing deemed suitable.

### Articles of Manufacture

As shown in FIG. 6, the present invention also includes articles comprising a product composition 400 and a water-soluble film with an integrated water-dispersible barrier 100 which may be formed into a container 300, such as a pouch, a sachet, a capsule, a bag, etc. to hold the product composition. The surface of a water-soluble polymeric layer opposite the surface which has the water-dispersible barrier layer applied thereto, may be used to form an outside surface of the container 300. The water-soluble film with an integrated water-dispersible barrier 100 may form at least a portion of a container 300 that provides a unit dose of the product composition 400. For simplicity, the articles of interest herein will be described in terms of water-soluble pouches, although it should be understood that discussion herein also applies to other types of containers.

The pouches 300 formed by the foregoing methods, can be of any form and shape which is suitable to hold the composition 400 contained therein, until it is desired to release the composition 400 from the water-soluble pouch 300, such as by immersion of the water-soluble pouch 300 in water. The pouches 300 can comprise one compartment, or two or more compartments (that is, the pouches can be multi-compartment pouches). In one embodiment, the water-soluble pouch 300 may have two or more compartments that are in a generally superposed relationship and the pouch 300 comprises upper and lower generally opposing outer walls, skirt-like side walls, forming the sides of the pouch 300, and one or more internal partitioning walls, separating different compartments from one another. If the composition 400 contained in the pouches 300 comprises different forms or components, the different components of the composition 400 may be contained in different compartments of the water-soluble pouch 300 and may be separated from one another by a barrier of water-soluble material.

The pouches or other containers 300 may contain a unit dose of one or more compositions 400 for use as/in laundry detergent compositions, automatic dishwashing detergent compositions, hard surface cleaners, stain removers, fabric enhancers and/or fabric softeners, hair care compositions, beauty care compositions, oral care compositions, health care compositions, personal cleansing compositions, and household cleansing compositions; for example shampoo, conditioner, mousse, face soap, hand soap, body soap, liquid soap, bar soap, moisturizer, skin lotion, shave lotion, toothpaste, mouthwash, hair gel, hand sanitizer, laundry detergent compositions dishwashing detergent, automatic dishwashing machine detergent compositions, cosmetics, and over-the-counter medication, razors, absorbent articles, wipes, hair gels, food and beverage, animal food products, menstrual cups, exfoliating pads, electrical and electronic consumer devices, brushes, applicators, ear plugs, eye masks, eye patches, face masks, agricultural products, plant food, plant seeds, insecticides, ant killers, alcoholic beverages, animal food products, electronics, pharmaceuticals, confectionary, petfood, pet healthcare products, cannabis derived products, hemp derived products, CBD based products, other products derived from drugs other than cannabis, vitamins, non-pharmaceutical natural/herbal “wellness” products, food and beverage and new product forms where contact with small amounts of water could create premature pouch dissolution, unwanted pouch leakage and/or undesirable pouch-to-pouch stickiness. Typical absorbent articles of the present invention include but are not limited to diapers, adult incontinence briefs, training pants, diaper holders, menstrual pads, incontinence pads, liners, absorbent inserts, pantiliners, tampons, period pants, sponges, tissues, paper towels, wipes, flannels and the like. Pouch stickiness from migrating chemistries from within the formulated product will also be reduced. The composition 400 in the pouches 300 can be in any suitable form including, but not limited to: liquids, gels, pastes, creams, solids, granules, powders, capsules, pills, dragees, solid foams, fibers, etc. The different compartments of multi-compartment pouches 300 may be used to separate incompatible ingredients. For example, it may be desirable to separate bleaches and enzymes into separate compartments. Due to likely improvements in barrier performance, the dyes and perfumes typically used in some Fabric and Home Care products should have greater stability inside these new pouches. Other forms of multi-compartment embodiments may include a powder-containing compartment in combination with a liquid-containing compartment. Additional examples of multiple compartment water-soluble pouches are disclosed in U.S. Pat. No. 6,670,314 B2, Smith, et al.

The water-soluble pouches 300 may be dropped into any suitable aqueous solution (such as hot or cold water), whereupon water-soluble film with an integrated water-dispersible barrier 100 forming the water-soluble pouches 300 dissolves to release the contents of the pouches. The water-soluble film with an integrated water-dispersible barrier 100 described herein can also be used for coating products and other articles. Non-limiting examples of such a product are laundry detergent tablets or automatic dishwashing detergent tablets. Other examples include coating products in the food and beverage category where contact with small amounts of water could create premature dissolution, unwanted leakage and/or undesirable stickiness.

Additional product forms (articles) include, disposable aprons, laundry bags, disposable hospital bedding, skin patches, face masks, disposable gloves, disposable hospital gowns, medical equipment, skin wraps, agricultural mulch films, shopping bags, sandwich bags, trash bags, emergency blankets and clothing, building/construction wrap & moisture resistant liners, primary packaging for shipping, such as envelopes and mailers, non-absorbent clothing articles that can be used to encase clothing items, for example dresses, shirts, suits, and shoes.

### Test Methods

When testing and/or measuring a material, if the relevant test method does not specify a particular temperature, then the test and/or measure is performed on specimens at 23° C. (±3° C.), with such specimens preconditioned at that temperature. When testing and/or measuring a material, if the relevant test method does not specify a particular humidity, then the test and/or measure is performed on specimens at 35% (±5%), with such specimens preconditioned at that humidity. Testing and/or measuring should be conducted by trained, skilled, and experienced personnel, according to good laboratory practices, via properly calibrated equipment and/or instruments.

1) Film Dissolution in Water

This test method measures the total time for the complete dissolution of a particular film specimen when the test is performed according to Slide Dissolution Test, which is Test Method 205 (MSTM 205), as set forth in paragraphs 116-131 of US published patent application US20150093526A1, entitled “Water-soluble film having improved dissolution and stress properties, and packets made therefrom”. The entire publication is hereby incorporated as reference. The dissolution test method used herein is the same as that set forth in US20150093526A1, except that the temperature of the distilled water is 23° C., the beaker diameter is about 10 cm and the test duration limit is 24 hours. The results are Individual and Average Disintegration Time (the time to where the film beaks apart) and Individual and Average Dissolution Time (the time to where no solid residues are visible). Unless explicitly specified, Dissolution Test Method uses distilled water maintained at 23° C. The Dissolution Test Method does not apply to materials other than films having an overall thickness equal or less than 3 mm A film according to the present invention is considered water-soluble if the average dissolution time measured according to this dissolution test method is less than 24 hours.

2) Water Vapour Transmission Rate

This test method is performed according to ASTM F1249-13 under the following test conditions: temperature of 40° C. (±0.56° C.) and relative humidity of 50% (±3%) or 90% (±3%). The water vapour transmission rate was measured by the instrument Permatran-W Model 3/33 from Mocon in Minneapolis (USA) and is reported in [g/m²/day]. For materials outside of the Scope (§ 1.1) of ASTM F-1249-13, the water vapour transmission rate test method does not apply.

3) Overall Film/Individual Layers Thickness

The thickness of the overall film/individual layers is measured by cutting a 20 μm thick cross-section of a film sample via sliding microtome (e.g. Leica SM2010 R), placing it under an optical microscope in light transmission mode (e.g. Leica Diaplan), and applying an imaging analysis software. Water-dispersible nanoplatelets layers contrast strongly with water-soluble polymeric layers. In case of adjacent water-soluble polymeric layers, the contrast can be achieved by adding different tracers such as 0.5% rhodamine B or 0.5% titan dioxide nanoparticles by weight.

4) Scanning Electron Microscopy

SEM images were recorded by the instrument Zeiss Ultra Plus from Carl Zeiss AG (Oberkochen, Germany) operating at 3.0 kV equipped with an in-lens secondary detector. The sample specimen was prepared by cutting via scalpel a cross-section of the film at room temperature condition.

### EXAMPLES

### Preparation of Water-Soluble Polyvinyl Alcohol (PVOH) Solution (30% Solids)

1070 g of demineralized water is heated up in a Thermomix TM5 to 50° C. 400 g of solid PVOH powder (Selvol 205 ex Sekisui Chemical Co., Tokyo, Japan) is added under stirring at level 2.5-3.0 and temperature is set to 85° C. When the temperature of 85° C. is reached, (in about 5 min), the stirring level is reduced to 1.0-1.5 to avoid extreme foaming After 30 min of constant stirring at 85° C., the polymer is dissolved. In parallel, 50 g sorbitol and 50 g glycerol are mixed with 100 g demineralized water at 85° C. Then, both polymer and plasticizer solutions are mixed at 85° C. under stirring level 1.0-1.5 for about 5 min. The solution is stored over night at RT to eliminate any residual foam.

### Preparation of Water-Soluble Polyethylene Oxide (PEO) Solution (30% Solids)

1070 g of demineralized water is heated up in a Thermomix TM5 to 50° C. 400 g of solid PEO powder (WSR N-80 ex Dow Chemicals Inc, Midland, Mich.) is carefully added step by step under stirring at level 2.5-3.0 and temperature is set to 85° C. After 3 hours of constant stirring at 85° C., the polymer is dissolved. In parallel, 50 g glycerol and 50 g sorbitol are mixed with 100 g demineralized water at 85° C. Finally, both polymer and plasticizer solutions are mixed at 85° C. under stirring at level 2.5-3.0 for about 5-10 min. The solution is stored then over night at room temperature.

### Preparation of Water-Soluble Hypromellose (HPMC) Solution (20% Solids)

1900 g of demineralized water is heated up in a Thermomix TM5 to 50° C. 400 g of solid hypromellose powder (E15LV ex Parchem Chemicals) is added under stirring at level 2.5-3.0 and temperature is set to 85° C. When the temperature of 85° C. is reached, (in about 5 min), the stirring level is reduced to 1.0-1.5 to avoid extreme foaming After 30 min of constant stirring at 85° C., the polymer is dissolved. In parallel, 50 g sorbitol and 50 g glycerol are mixed with 100 g demineralized water at 85° C. Then, both polymer and plasticizer solutions are mixed at 85° C. under stirring level 1.0-1.5 for about 5 min. The solution is stored over night at 60° C. to eliminate any residual foam and the evaporated water is compensated with additional demineralized water.

### Preparation of Water-Soluble Alginate Solution (15% Solids)

1370 g of demineralized water is heated up in a Thermomix TM5 to 50° C. 200 g of solid Na-Alginate powder (Vivastar CS002 ex JRS) is carefully added step by step under stirring at level 2.5-3.0 and temperature is set to 85° C. After 3 hours of constant stirring at 85° C., the polymer is dissolved. In parallel, 25 g glycerol and 25 g sorbitol are mixed with 50 g demineralized water at 85° C. Finally, both polymer and plasticizer solutions are mixed at 85° C. under stirring at level 2.5-3.0 for about 5-10 min. The solution is stored then over night at room temperature.

### Preparation of Water-Dispersible Cloisite Dispersion (7% Solids)

Cloisite is a natural bentonite, purified and cation exchanged from Ca²⁺ to Na⁺ by BYK to enable its complete exfoliation in water. The aspect ratio is then about 200. 1120 g of demineralized water is heated up in a Thermomix TM5 to 50° C. 100 g of master-batch paste (CNaMGH ex MBN Nanomaterialia consisting of 80% sodium cloisite ex BYK exfoliated in 20% water) is added under stirring at level 3.0. Once completed, the stirring level is increased to 5.0 and the residual paste agglomerates are scrapped off the mixing container wall/mixer blades. After 30 min of constant stirring at level 5.0 the nanoplatelets are homogeneously dispersed forming a brownish viscous liquid/gel, leaving some residues at the wall of the container that must be removed via scraper.

### Preparation of Water-Dispersible Hectorite Dispersion (6% Solids)

Sodium hectorite [Na_{0.5}]^{inter}[Mg_{2.5}Li_{0.5}]^{oct}[Si₄]^{tet}O₁₀F₂ was synthesized, as follows: High purity reagents of SiO₂ (Merck, fine granular, washed and calcined quartz), LiF (ChemPur, 99.9%, powder), MgF₂ (ChemPur, 99.9%, 3-6 mm pieces, fused), MgO (Alfa Aesar, 99.95%, 1-3 mm fused lumps) and NaF (Alfa Aesar, 99.995%, powder) were carefully weighed according to the composition in the formula. Crucibles made of molybdenum (25 mm outer diameter, 21 mm inner diameter, 180 mm length) were supplied by Plansee SE (Reutte, Austria). These crucibles were first heated up to 1600° C. under vacuum inside a quartz tube placed within a copper based high-frequency induction heating coil for cleaning purpose. The reagents were then added into a crucible under argon atmosphere (glovebox) and heated up to 1200° C. under vacuum to remove any residual water. The crucible was then sealed with a molybdenum lid by heating both parts up to the melting point of molybdenum. The sealed crucible was thus placed horizontally in a graphite furnace under argon atmosphere and rotated at 1750° C. for 80 min. The crucible was then opened, the resulting sodium hectorite was collected, grinded via planetary ball mill, and dried in a clean crucible at 250° C. under argon atmosphere for 14 hours. The crucible was then sealed with a molybdenum lid and annealed at 1045° C. for 6 weeks in a graphite furnace to increase the homogeneity of the sodium hectorite. The material was then placed in a desiccator at (23° C., 43% rH) to reach the hydrated formula [Na_{0.5}]^{inter}[Mg_{2.5}Li_{0.5}]^{oct}[Si₄]^{tet}O₁₀F₂.[H₂O]₂. Bi-distilled water was then added to reach 6% hectorite dispersion in water. Finally, the dispersion was left 2 weeks at 23° C. to complete the hectorite nanoplatelets exfoliation. The aspect ratio is then about 20000.

Lab-Scale Making of Water-Soluble Film with Integrated Water-Dispersible Barrier

All aqueous solutions/dispersion were homogenized at 2500 rpm and degassed at (23° C., 50 mbar) using a SpeedMixer DAC 400.2 VAC-P from Hauschild & Co KG (Hamm, Germany) for 5 min. prior to their usage. The multilayer film was made via slot die coating using a lab-scale TSE Table Coater equipped with a 300 mm wide monolayer slot die (coating width 210 mm, shim thickness 165 μm) and a unidirectional moving vacuum table. The vacuum table supported and fixed the carrier film needed for the first wet coating. Once coated, the aqueous solutions/dispersion were dried by heating the vacuum table up to 50° C. The drying process was accelerated by soft and uniform vapour aspiration through a microporous plate located parallel and above the wet coated surface.

1) Water-Soluble PVOH Film with Integrated Water-Dispersible Hectorite Barrier

In one embodiment, a first water-soluble polymeric layer was formed by coating an aqueous PVOH solution (30% solids) at 23° C. onto an untreated PLA carrier film (BOPLA-Folie NTSS 25 NT ex Paz GmbH+Co Folien KG (Taunusstein, Germany) To do so, the gap between slot die and applied surface was set to 205 μm, the pump flow rate was set to 2.52 ml/min, the table speed was set to 0.1 m/min. The wet coating was dried for 15 min at 60° C. and the resulting dry layer composition was 80% PVOH, 10% glycerol, 10% sorbitol. The water-dispersible nanoplatelets layer was then added by coating an aqueous sodium hectorite dispersion (6% solids) at 23° C. To do so, the gap between slot die and applied surface was set to 385 μm, the pump flow rate was set to 4.6 ml/min, the table speed was set to 0.1 m/min. The wet coating was dried for 7 days at 23° C. and the resulting dry layer composition was 100% sodium hectorite. The second water-soluble polymeric layer was added by coating an aqueous PVOH solution (30% solids) at 23° C. To do so, the gap between slot die and applied surface was set to 250 μm, the pump flow rate was set to 2.52 ml/min, the table speed was set to 0.1 m/min. The wet coating was dried for 30 min. at 60° C. and the resulting dry layer composition was 80% PVOH, 10% glycerol, 10% sorbitol.

2) Water-Soluble Hypromellose Film with Integrated Water-Dispersible Hectorite Barrier

In one embodiment, a first water-soluble polymeric layer was formed by coating an aqueous hypromellose solution (20% solids) at 23° C. onto an untreated PLA carrier film (BOPLA-Folie NTSS 25 NT ex Putz Folien (Germany). To do so, the gap between slot die and applied surface was set to 450 μm, the pump flow rate was set to 5.9 ml/min, the table speed was set to 0.1 m/min. The wet coating was dried for 1 hour at 50° C. and the resulting dry layer composition was 80% hypromellose, 10% glycerol, 10% sorbitol. The water-dispersible nanoplatelets layer was then added by coating an aqueous sodium hectorite dispersion (6% solids) at 23° C. To do so, the gap between slot die and applied surface was set to 385 μm, the pump flow rate was set to 4.6 ml/min, the table speed was set to 0.1 m/min. The wet coating was dried for 7 days at 23° C. and the resulting dry layer composition was 100% sodium hectorite. The second water-soluble polymeric layer was added by coating an aqueous hypromellose solution (20% solids) at 23° C. To do so, the gap between slot die and applied surface was set to 480 μm, the pump flow rate was set to 5.9 ml/min, the table speed was set to 0.1 m/min. The wet coating was dried for 2 hours at 50° C. and the resulting dry layer composition was 80% hypromellose, 10% glycerol, 10% sorbitol.

3) Water-Soluble Alginate Film with Integrated Water-Dispersible Hectorite Barrier

In one embodiment, a first water-soluble polymeric layer was formed by coating an aqueous alginate solution (15% solids) at 23° C. onto an untreated PLA carrier film (BOPLA-Folie NTSS 25 NT ex Putz Folien (Germany) To do so, the gap between slot die and applied surface was set to 475 μm, the pump flow rate was set to 1.92 ml/min, the table speed was set to 0.03 m/min. The wet coating was dried for 1 hour at 23° C. and the resulting dry layer composition was 80% alginate, 10% glycerol, 10% sorbitol. The water-dispersible nanoplatelets layer was then added by coating an aqueous sodium hectorite dispersion (6% solids) at 23° C. To do so, the gap between slot die and applied surface was set to 385 μm, the pump flow rate was set to 4.6 ml/min, the table speed was set to 0.1 m/min. The wet coating was dried for 7 days at 23° C. and the resulting dry layer composition was 100% sodium hectorite. The second water-soluble polymeric layer was added by coating an aqueous alginate solution (15% solids) at 23° C. To do so, the gap between slot die and applied surface was set to 500 μm, the pump flow rate was set to 1.92 ml/min, the table speed was set to 0.03 m/min. The wet coating was dried for 2 hours at 23° C. and the resulting dry layer composition was 80% alginate, 10% glycerol, 10% sorbitol.

TABLE 1

| | | | | | | Disintegration | Dissolution |
|---|---|---|---|---|---|---|---|
| | | | Layers | | WVTR | in 23° C. | in 23° C. |
| | Water-soluble | WSR | Hectorite | WSR | (40° C., 50% rH) | Water | Water |
| Sample | Resin | [μm] | [μm] | [μm] | [g/m²/day] | [min] | [min] |
| SAMPLE 1 | PVOH Selvol 205 | 30 | 5.4 | 30 | 0.06 | 5.7 ± 1.3 | 9.7 ± 2.1 |
| SAMPLE 2 | HPMC E15LV | 43 | 5.4 | 43 | 0.10 | 5.9 ± 2.1 | 7.4 ± 2.1 |
| SAMPLE 3 | Alginate CS002 | 35 | 5.4 | 35 | 0.35 | 2.9 ± 0.9 | 4.3 ± 0.6 |

Pilot-Scale Making of Water-Soluble Film with Integrated Water-Dispersible Barrier

4) Water-Soluble PVOH Film with Integrated Water-Dispersible Cloisite Barrier

In one embodiment, a first single water-soluble polymeric layer was formed by slot die coating 100μ aqueous PVOH solution at 85° C. onto an untreated PET carrier film (Hostaphan RN 50-350 ex Mitsubishi) via slot die from FMP Technology and the water removed via convective drier from FMP Technology set at 95° C. The composition of the resulting 30μ dry layer was 80% Selvol 205 ex Sekisui Chemicals, 10% glycerol and 10% sorbitol. The water-dispersible nanoplatelets layer was then added by slot die coating 100μ aqueous cloisite dispersion at 50° C. onto the first single water-soluble polymeric layer via slot die from FMP Technology and the water removed via convective drier from FMP Technology set at 95° C. The composition of the resulting 7μ dry layer was 100% sodium cloisite ex BYK. A second single water-soluble polymeric layer was formed by slot die coating 100μ aqueous PVOH solution at 85° C. onto the water-dispersible nanoplatelets layer via slot die from FMP Technology and the water removed via convective drier from FMP Technology set at 95° C. The composition of the resulting 30μ dry layer was 80% Selvol 205 ex Sekisui Chemicals, 10% glycerol and 10% sorbitol.

In this embodiment, the water was removed from the aqueous nanoplatelets dispersion by setting different temperatures in the convective dryer. As shown in Table 2, drying temperatures ranging within 50-95° C. did not deliver significant differences in the barrier performance of the water-dispersible nanoplatelets layer. The WVTR measured at [40° C., 50%] according to the method ASTM F1249-13 is equal to 8.1±0.6 [g/m²/day]. Using a barrier thickness of 7.2±0.2 μm, the Water Vapour Permeation (WVP) is then equal to about 1600±100 [g·μm/m²/day/bar]. This value is specific to the properties of sodium cloisite material and of the slot die coating process.

TABLE 2

| | | | PVOH | Cloisite | PVOH | WVTR at |
|---|---|---|---|---|---|---|
| | | Drier | layer | layer | layer | (40° C., 50% rH) |
| Sample | Process | [° C.] | [μm] | [μm] | [μm] | [g/m²/day] |
| SAMPLE 4 | Slot Die | 95 | 30 | 7.0 | 30 | 7.87 ± 0.93 |
| SAMPLE 5 | Slot Die | 75 | 30 | 7.2 | 30 | 8.40 ± 0.53 |
| SAMPLE 6 | Slot Die | 65 | 30 | 7.3 | 30 | 8.77 ± 0.84 |
| SAMPLE 7 | Slot Die | 50 | 30 | 7.3 | 30 | 8.05 ± 0.51 |
| SAMPLE 8 | Slot Die | 23 | 30 | 7.4 | 30 | 7.24 ± 0.88 |

In another embodiment, a first single water-soluble polymeric layer was formed by coating 50μ aqueous PVOH solution at 80° C. onto an untreated PET carrier film (Hostaphan RN 50-350 ex Mitsubishi Polyester Film GmbH, Wiesbaden, Germany) via anilox roll and the water removed via convective drier from Drytec set at 95° C. The composition of the resulting 13μ dry layer was 80% Selvol 205 ex Sekisui Chemicals, 10% glycerol and 10% sorbitol. A second and third water-soluble polymeric layers were added onto the first single water-soluble polymeric layer via the same process. The water-dispersible nanoplatelets layer was then added by coating 100μ aqueous cloisite dispersion at 50° C. onto the water-soluble polymeric layer via reverse roll and the water removed via convective dryer from Drytec set at 95° C. The composition of the resulting 7μ dry layer was 100% sodium cloisite ex BYK. Three additional water-soluble polymeric layers were added onto the water-dispersible nanoplatelets layer via anilox roll coating.

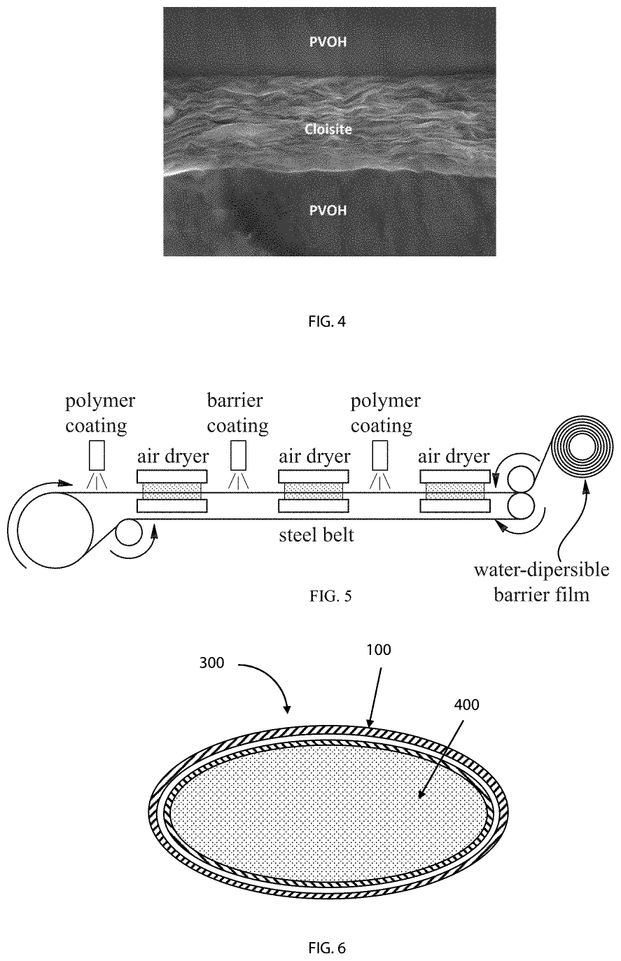

A picture of the water-dispersible cloisite layer lying between the upper and lower water-soluble PVOH layers is shown in FIG. 4. This picture was obtained via scanning electron microscopy of a thin 20 μm cross-section of the water-soluble multilayer film and magnified around×20,000.

In such embodiment, the aqueous cloisite dispersion was further diluted from 7% to 3% solids to decrease the dispersion viscosity and to improve the coating process (e.g. line speed, coating quality). However, as shown in Table 3, lower [% solids] in the aqueous cloisite dispersion also lead to surprisingly lower barrier performance, perhaps because lower [% solids] lead to higher water-soluble polymeric intercalation in the water-dispersible nanoplatelets layer.

TABLE 3

| | | | PVOH | Cloisite | PVOH | WVTR at |
|---|---|---|---|---|---|---|
| | | Dispersion | layer | layer | layer | (40° C., 50% rH) |
| Sample | Process | [% solids] | [μm] | [μm] | [μm] | [g/m²/day ] |
| SAMPLE 9 | Reverse Roll | 7 | 36 | 7.7 | 36 | 7.1 ± 1.0 |
| SAMPLE 10 | Reverse Roll | 6 | 36 | 6.2 | 36 | 22.7 ± 1.7 |
| SAMPLE 11 | Reverse Roll | 5 | 36 | 5.8 | 36 | 69.2 ± 2.0 |
| SAMPLE 12 | Reverse Roll | 4 | 36 | 5.7 | 36 | 64.6 ± 2.5 |
| SAMPLE 13 | Reverse Roll | 3 | 36 | 1.9 | 36 | 69.0 ± 1.9 |

A comparative example was made according to the method outlined above, but without integrating the water-dispersible nanoplatelets layer. As shown in Table 4, the barrier performance of the comparative example is significantly lower: The WVTR measured at [40° C., 50%] according to the method ASTM F1249-13 is equal to 47.2±1.1 [g/m²/day]. compared with 7.1±1.0 [g/m²/day] obtained with an integrated water-dispersible cloisite barrier.

TABLE 4

| | | | PVOH | Cloisite | PVOH | WVTR at |
|---|---|---|---|---|---|---|
| | | Dispersion | layer | layer | layer | (40° C., 50% rH) |
| Sample | Process | [% solids] | [μm] | [μm] | [μm] | [g/m²/day ] |
| SAMPLE 9 | Reverse Roll | 7 | 36 | 7.7 | 36 | 7.1 ± 1.0 |
| SAMPLE 14 | Reverse Roll | — | 34 | 0 | 15 | 47.2 ± 1.1 |

5) Water-Soluble PEO Film with Integrated Water-Dispersible Cloisite Barrier

In one embodiment, a first single water-soluble polymeric layer was formed by extrusion coating 100μ aqueous PEO solution at 85° C. onto an untreated PET carrier film (Hostaphan RN 50-350 ex Mitsubishi) via slot die from FMP Technology and the water removed via convective drier from FMP Technology set at 95° C. The composition of the resulting 34μ dry layer was 80% WSR N-80 ex Dow Chemicals, 10% glycerol and 10% sorbitol. The water-dispersible nanoplatelets layer was then added by extrusion coating 100μ aqueous cloisite dispersion at 50° C. onto the first single water-soluble polymeric layer via slot die from FMP Technology and the water removed via convective drier from FMP Technology set at 95° C. The composition of the resulting 5μ dry layer was 100% sodium cloisite ex BYK. A second single water-soluble polymeric layer was formed by extrusion coating 100μ aqueous PEO solution at 85° C. onto the water-dispersible nanoplatelets layer via slot die from FMP Technology and the water removed via convective drier from FMP Technology set at 95° C. The composition of the resulting 34μ dry layer was 80% WSR N-80 ex Dow Chemicals, 10% glycerol and 10% sorbitol.

TABLE 5

| | | | | | | Disintegration | Dissolution |
|---|---|---|---|---|---|---|---|
| | | | Layers | | WVTR | in 23° C. | in 23° C. |
| | | PEO | Cloisite | PEO | (38° C., 90% rH) | Water | Water |
| Sample | Process | [μm] | [μm] | [μm] | [g/m²/day] | [min] | [min] |
| SAMPLE 15 | Slot Die | 34 | 0.0 | 34 | 681 ± 102 | 0.9 ± 0.1 | 1.8 ± 0.2 |
| SAMPLE 16 | Slot Die | 34 | 5.4 | 34 | 14.1 ± 0.2 | 1.0 ± 0.1 | 1.9 ± 0.1 |

As shown in Table 5, the barrier improvement factor of the water-soluble PEO film is high (about factor×50), measured at high relative humidity levels (90%), with integrated water-dispersible cloisite barrier, making this option particularly attractive for flexible packaging applications.

### Comparative Examples

The below comparative examples consist of water-soluble films with an integrated barrier layer made of non-dispersible barrier materials in water, therefore not suitable for this application.

Preparation of the PVDC solution (20% solids) 1000 g of methyl-ethyl-ketone (MEK) and ethyl-acetate (EA) solvent mixture (60:40) is heated up in a glass beaker to 50° C. inside a protective fume hood. 200 g of polyvinylidene dichloride, powder grade Resin F310 ex Asahi Kasei is added under magnetic stirring. Once completed, the stirring level is increased to the maximum level and the heating is switched off. After about 2 hours of constant stirring at maximum level, the PVDC powder is completely dissolved. The solution is stored over night at room temperature (RT) to eliminate any residual foam.

Water-soluble PVOH film with integrated water insoluble PVDC barrier In one embodiment, a first single water-soluble polymeric layer was formed by coating 50μ aqueous PVOH solution at 80° C. onto an untreated PET carrier film (Hostaphan RN 50-350 ex Mitsubishi) via anilox roll and the water removed via convective drier from Drytec set at 95° C. The composition of the resulting 13μ dry layer was 80% Selvol 205 ex Sekisui Chemicals, 10% glycerol, 10% sorbitol and 1% Hecostat from Hecoplast. A second and third water-soluble polymeric layers were added onto the first single water-soluble polymeric layer via the same process. The non-dispersible PVDC barrier was then added by coating 30μ PVDC solution in MEK/EA at 50° C. onto the water-soluble polymeric layer via anilox roll and the MEK/EA solvent removed via convective dryer from Drytec set at 95° C. The composition of the resulting 3μ dry layer was 100% PVDC grade F310 ex Asahi Kasei. One additional water-soluble polymeric layer was added by coating 50μ aqueous PVOH solution at 80° C. onto the non-dispersible PVDC layer in water via anilox roll and the water removed via convective drier from Drytec set at 95° C. The composition of the resulting 15μ dry layer was 80% Selvol 205 ex Sekisui Chemicals, 10% glycerol, 10% sorbitol.

TABLE 6

| | | | | | | Disintegration | Dissolution |
|---|---|---|---|---|---|---|---|
| | | | Layers | | WVTR | in 23° C. | in 23° C. |
| | | PVOH | PVDC | PVOH | (40° C., 50% rH) | Water | Water |
| Sample | Process | [μm] | [μm] | [μm] | [g/m²/day] | [min] | [min] |
| SAMPLE 14 | Reverse Roll | 34 | 0 | 15 | 47.2 ± 1.1 | 0.1 ± 0.05 | 0.3 ± 0.03 |
| SAMPLE 17 | Anilox Roll | 39 | 3.0 | 15 | 13.0 ± 0.2 | none | none |
| | Coating | | | | | | |

As shown in table 6 above, although the middle PVDC layer reduces WVTR significantly, water insoluble PVDC does not meet the requirements of the invention according to this disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble film comprising:
a) a first water-soluble polymeric layer having a surface
b) a second water-soluble polymeric layer having a surface
c) a water-dispersible barrier layer disposed between the first and second layers

2. The water-soluble film of claim 1, wherein the polymeric layers are dissolved and the barrier layer dispersed within 24 hours of immersion in distilled water at 23° C.

3. The water-soluble film of claim 1, wherein the WVTR of the water-soluble film is from about 0.1 g/m²/day to about 100 g/m²/day when measured at 40° C. temperature and 50% relative humidity according to the ASTM test method F1249-13.

4. The water-soluble film of claim 1, wherein the WVTR of the water-soluble film is from about 0.1 g/m²/day to about 200 g/m²/day when measured at 38° C. temperature and 90% relative humidity according to the ASTM test method F1249-13.

5. The water-soluble film of claim 1, wherein the WVTR of the water-soluble film is from about 0.1 g/m²/day to about 200 g/m²/day when measured at 40° C. temperature and 50% relative humidity according to the ASTM test method F1249-13, even after mechanical stress, such as typical web handling stress or consumer handling stress.

6. The water-soluble film of claim 1, wherein the WVTR of the water-soluble film is from about 0.1 g/m²/day to about 200 g/m²/day when measured at 40° C. temperature and 50% relative humidity according to the ASTM test method F1249-13, even after exposure to several variation cycles of the environmental relative humidity between 10% and 90%.

7. The water-soluble film of claim 1, wherein the average thickness of the water-soluble polymeric layer is from about 1 μm to about 1000 μm.

8. The water-soluble film of claim 1, wherein the first and the second water-soluble polymeric layers comprises different water-soluble polymers.

9. The water-soluble film of claim 1, wherein at least one of the first or the second water-soluble polymeric layer comprises more than one water-soluble polymeric sublayer.

10. The water-soluble film of claim 1, wherein the water-soluble polymeric layers comprise a water-soluble polymer that is at least one of polyvinyl alcohol, polyethylene oxide, methylcellulose, or sodium alginate.

11. The water-soluble polymeric layers of claim 10, wherein the water-soluble polyvinyl alcohol is either homopolymer or copolymer, either partially or fully hydrolysed.

12. The water-soluble polymeric layers of claim 10, wherein the water-soluble polyvinyl alcohol has an average molecular weight from about 20,000 Da to about 150,000 Da.

13. The water-soluble polymeric layers of claim 10, wherein the water-soluble polyvinyl alcohol is a homopolymer with a degree of hydrolyzation from about 70% to about 100%.

14. The water-soluble polymeric layers of claim 10, wherein the water-soluble polyethylene oxide has an average molecular weight from about 50,000 Da to about 400,000 Da.

15. The water-soluble polymeric layers of claim 10, wherein the water-soluble methylcellulose has an average molecular weight from about 10,000 Da to about 100,000 Da.

16. The water-soluble polymeric layers of claim 10, wherein the water-soluble methylcellulose is methoxyl substituted from about 18% to about 32% and hydroxy-propoxyl substituted from about 4% to about 12%.

17. The water-soluble polymeric layers of claim 10, wherein the water-soluble sodium alginate has an average molecular weight from about 10,000 Da to about 240,000 Da.

18. The water-soluble film of claim 1, wherein the water-soluble polymeric layers comprise at least one water-soluble plasticizer.

19. The water-soluble polymeric layers of claim 18, wherein the plasticizer is at least one of water, glycerol, sorbitol, propylene glycol (PG), trimethylene glycol (PDO), trimethylolpropane (TMP), methylpropanediol (MPD), 2-methyl-1,3 propanediol (MPO), or mixtures thereof.

20. The water-soluble film of claim 1, wherein the water-dispersible barrier layer is distinct from the water-soluble polymeric layers when observed via optical microscopy or scanning electron microscopy.

21. The water-soluble film of claim 1, wherein the average thickness of the water-dispersible barrier layer is from about 0.1 μm to about 20 μm.

22. The water-soluble film of claim 1, wherein the water-dispersible barrier layer comprises more than one water-dispersible barrier sublayer.

23. The water-soluble film of claim 1, wherein the water-dispersible barrier layer comprises hydrophilic nanoplatelets.

24. The water-dispersible barrier layer of claim 23, wherein the average aspect ratio of the hydrophilic nanoplatelets is greater than about 100.

25. The water-dispersible barrier layer of claim 23, wherein the average aspect ratio of the hydrophilic nanoplatelets is from about 100 to about 20,000.

26. The water-dispersible barrier layer of claim 23, wherein the hydrophilic nanoplatelets are clay nanoplatelets or graphene oxide nanoplatelets.

27. The water-dispersible barrier layer of claim 26, wherein the hydrophilic nanoplatelets are smectites, such as natural montmorillonite or natural synthetic hectorite.

28. The water-dispersible barrier layer of claim 26, wherein the hydrophilic nanoplatelets are purified cation-exchanged bentonite traded as sodium cloisite or synthetic sodium hectorite.

29. A method of making a water-soluble film comprising:
a) applying a first aqueous solution of a water-soluble polymeric composition onto the surface of a removeable flat carrier, such as PET films or steel belts
b) removing the water from the first aqueous solution of a water-soluble polymeric composition to obtain a first water-soluble polymeric layer
c) applying an aqueous dispersion of hydrophilic nanoplatelets onto the surface of the first water-soluble polymeric layer
d) removing the water from the aqueous dispersion of hydrophilic nanoplatelets to obtain a water-dispersible barrier layer
e) applying a second aqueous solution of a water-soluble polymeric composition onto the surface of the water-dispersible barrier layer
f) removing the water from the second aqueous solution of a water-soluble polymeric composition to obtain a second water-soluble polymeric layer
g) removing the flat carrier from the resulting water-soluble barrier film.

30. The method of claim 29, wherein the water transferred from the applied aqueous nanoplatelets dispersion onto the water-soluble polymeric layer is below the dissolution point of the water-soluble polymeric layer in water.

31. The method of claim 29, wherein the water transferred from the applied aqueous polymeric solution onto the water-dispersible nanoplatelets layer is below the dissolution point of the water-dispersible nanoplatelets layer in water.

32. The method of claim 29, wherein the aqueous polymeric solution is applied via coating processes.

33. The method of claim 29, wherein the aqueous nanoplatelets dispersion is applied via coating processes.
